(19) United States
(12) Patent Application Publication
(10) Pub. No.: US 2025/0079834 A1
(43) Pub. Date: Mar. 6, 2025

(54) QUANTUM-COMPUTING-ENHANCED HYBRID RENEWABLE ENERGY NETWORK OPTIMIZATION

(71) Applicant: PwC Product Sales LLC, New York, NY (US)

(72) Inventors: Zhijie TANG, Zhejiang (CN); Alex Lu DOU, Shanghai (CN); Arit Kumar BISHWAS, San Francisco, CA (US)

(73) Assignee: PwC Product Sales LLC, New York, NY (US)

(21) Appl. No.: 18/240,889

(22) Filed: Aug. 31, 2023

(51) Int. Cl. H02J 3/00; G06N 10/60

(52) U.S. Cl. CPC H02J 3/003; G06N 10/60; H02J 2203/20

(57) ABSTRACT

A method for operating a hybrid energy network comprising a plurality of power sources is described. After receiving information indicating predicted operating conditions of the hybrid energy network, the values of one or more constraints associated with an objective function that defines a relationship between a plurality of performance parameters associated with the hybrid energy network may be updated. Using a quantum computing system, an optimal value of each of the plurality of performance parameters may be determined. Based on the optimal values of each of the plurality of performance parameters, an operating plan for the hybrid energy network may be determined. Adjustments may be made to at least one of power sources according to the generated operating plan.

### FIELD

This disclosure generally relates to renewable energy, in particular to techniques for improving the performance of renewable energy networks using quantum computing.

### BACKGROUND

As energy demands escalate due to societal growth and advancement, increased pressure is placed upon traditional, fossil-fuel-based power sources such as oil and natural gas. The widespread use of these traditional power sources has been tied to environmental issues, including climate change. Furthermore, traditional power sources are not renewable; as such, the proportion of overall energy demand that can be satisfied with traditional power sources may plateau or shrink in the future as supplies of said power sources are depleted.

The disadvantages of traditional, non-renewable power sources have sparked interest in renewable power sources as potential alternatives for meeting energy demands. Since the availability of many renewable power sources is frequently unpredictable (e.g., due to daily changes in the weather at a given power-sourcing location), hybrid energy networks capable of drawing energy from numerous power sources have started to emerge. However, challenges associated with determining when and how much energy should be drawn from a given power source restrict the scale at which hybrid energy networks can be implemented.

### SUMMARY

In order for a hybrid energy network to function efficiently and reliably, the network must predict and compensate for fluctuations in the amount of energy that each power source in the system can provide at a given time. The ability of an energy network to draw power from a power source may be affected by a myriad of (potentially volatile) factors, including weather patterns and the system's energy storage and transport capabilities. As a result, managing the performance and power output of a hybrid energy network may be a challenging and computationally complex endeavor.

Accordingly, described are methods for utilizing quantum computing to optimize the performance of a hybrid energy network. Quantum computers are capable of solving computationally complex (e.g., NP-hard) problems at higher speeds than classical computers. By harnessing the advantages in computing ability provided by quantum computers, the techniques provided herein enable optimal values of time-dependent performance parameters such as the amount of power that is output by each power source in a hybrid energy network to be determined. These optimized performance parameters can then be used to prepare the system to meet energy demands while minimizing the economic burden on consumers.

A system configured to execute the described methods may include a classical computing system and a quantum computing system. The classical computing system may interface with various information sources to receive up-to-date information associated with a hybrid energy network. This information may include data related to weather conditions in a vicinity of the hybrid energy network as well predictions about upcoming energy demands on the hybrid energy network. Using the input information, the classical computing system may update the values of one or more variables in an objective function that defines the relationships between a set of performance parameters for the hybrid energy network. The objective function may then be provided to the quantum computing system, which may determine optimal values of the performance parameters by minimizing the objective function using a quantum computational optimization process such as quantum annealing.

Based on the values of the performance parameters determined by the quantum computing system, the classical computing system may generate a plan for operating the hybrid energy network during an upcoming time period. The operating plan may then be implemented to improve the performance of the hybrid energy network. In some cases, the plan may be implemented automatically, for example by using the classical computing system to control the amount of energy that is drawn from the power sources during a given time period. This may allow the energy network to provide consistent, reliable power to consumers in the face of operating conditions that may be constantly changing.

A method for operating a hybrid energy network comprising a plurality of power sources may comprise receiving information indicating predicted operating conditions of the hybrid energy network, updating, based on the received information, values of one or more constraints associated with an objective function that defines a relationship between a plurality of performance parameters associated with the hybrid energy network, determining, using a quantum computing system, based on the objective function and the updated values of the one or more constraints, an optimal value of each of the plurality of performance parameters, generating an operating plan for the hybrid energy network based on the optimal values of each of the plurality of performance parameters, and causing an adjustment to be made to at least one of the plurality of power sources according to the generated operating plan. Causing an adjustment to be made to at least one of the plurality of power sources according to the generated operating plan may comprise automatically updating an amount of power sourced from each of the plurality of power sources.

The quantum computing system may be a quantum annealer. Determining the optimal values of the plurality of performance parameters can involve solving a quadratic unconstrained binary optimization (QUBO) problem or solving a constrained quadratic model (CQM) problem. The information indicating predicted operating conditions of the hybrid energy network may include information about a predicted weather condition, information about a predicted load on an energy store of the hybrid energy network, or a combination thereof. A first constraint of the one or more constraints associated with the objective function may indicate a maximum amount of power that a power source of the plurality of power sources is capable of outputting during a given time period. A second constraint of the one or more constraints associated with the objective function may indicate a minimum total amount of power that the hybrid energy network should produce during a given time period. A third constraint of the one or more constraints associated with the objective function may indicate a maximum total amount of power that the hybrid energy network should produce during a given time period. A fourth constraint of the one or more constraints associated with the objective function may indicate a maximum energy storage capacity of the hybrid energy network. The objective function may include a first term configured to capture a monetary cost associated with operating the hybrid energy network during a given time period and a second term configured to capture a fluctuation rate of a total amount of power output by the hybrid energy network during a given time period. Each of the plurality of performance parameters may to an amount of power sourced from a power source of the plurality of power sources.

A system for operating a hybrid energy network comprising a plurality of power sources may comprise a classical computing system and a quantum computing system. The system may be configured to receive, using the classical computing system, information indicating predicted operating conditions of the hybrid energy network. update, using the classical computing system, based on the received information, values of one or more constraints associated with an objective function that defines a relationship between a plurality of performance parameters associated with the hybrid energy network, determine, using the quantum computing system, based on the objective function and the updated values of the one or more constraints, an optimal value of each of the plurality of performance parameters, generate, using the classical computing system, an operating plan for the hybrid energy network based on the optimal values of each of the plurality of performance parameters, and cause, using the classical computing system, an adjustment to be made to at least one of the plurality of power sources according to the generated operating plan.

The quantum computing system may be a quantum annealer. The quantum computing system may determine the optimal values of the plurality of performance parameters by solving a quadratic unconstrained binary optimization (QUBO) problem or by solving a constrained quadratic model (CQM) problem. Each of the plurality of performance parameters corresponds to an amount of power sourced from a power source of the plurality of power sources. The classical computing system may be configured to cause adjustment to be made to at least one of the plurality of power sources according to the generated operating plan by automatically updating an amount of power sourced from each of the plurality of power sources.

### BRIEF DESCRIPTION OF THE DRAWINGS

The following figures show various systems and methods for improving the performance of a hybrid energy network using quantum computing, according to some embodiments. The systems and methods shown in the figures may have any one or more of the characteristics described herein.

FIG. 1A shows a block diagram of a system for improving the performance of a hybrid energy network, according to some embodiments.

FIG. 1B shows components of a classical computing system, according to some embodiments.

FIG. 1C shows components of a quantum computing system, according to some embodiments.

FIG. 2 shows a method for improving the performance of a hybrid energy network, according to some embodiments.

FIG. 3A shows a graphical representation of a method for determining the optimal values of performance parameters for a hybrid energy network using quantum annealing, according to some embodiments.

FIG. 3B shows a method for determining the optimal values of performance parameters for a hybrid energy network using quantum annealing, according to some embodiments.

FIG. 4 shows data comparing the energy output of a hybrid energy network when it is operated according to the methods described herein to the energy output of the hybrid energy network when it is operated using solely classical techniques.

### DETAILED DESCRIPTION

As discussed, a hybrid energy network is a system made up of multiple distinct types of power sources. The capability to draw from numerous sources of power may allow the network to compensate for supply deficiencies in one power source using energy from one or more of the other sources in the network. Hybrid renewable energy networks that can harness energy from two or more renewable power sources are of particular interest. A hybrid renewable energy network that reliably produces enough energy to meet consumer demands may enable large-scale reductions in dependence on non-renewable power sources such as fossil fuels.

The efficiency and reliability of a hybrid energy network may hinge on the system's ability to adapt to dynamic operation conditions. Specifically, the energy network may need to be capable of supplying consistent amounts of power to the electrical grid to which it is connected. This may require continuous adjustments to be made to numerous performance parameters (e.g., the amount of energy drawn from each power source) associated with the energy network. Various constraining factors may impact the values of these performance parameter, including weather patterns in vicinity of the power source, economic costs associated with the power source, the efficiency of the power source, and the overall energy demand that must be satisfied. As such, managing the performance and power output of a hybrid energy network in a systematic manner may be difficult.

The provided systems and methods address the challenges associated operating a hybrid energy network by harnessing the computational capabilities of quantum computers. Quantum computers can provide fast and accurate solutions to computationally complex (e.g., NP-hard) optimization problems such as constrained quadratic model (CQM) problems and quadratic unconstrained binary optimization (QUBO) problems. The advantages in computing ability provided by quantum computers may allow optimal values of a plurality of performance parameters associated with a hybrid energy to be determined quickly and accurately, significantly increasing the adaptability of the hybrid energy network to a variety of unpredictable operating conditions. The provided systems and methods may therefore enable hybrid energy networks to provide consistent amounts of power, potentially expanding the scales at which such energy networks can be implemented.

In the systems and methods described herein, a classical computing system may be used to collect up-to-date information about operating conditions associated with a hybrid energy network from various information sources (e.g., databases storing weather data or energy demand data). This information may be used by the classical computing system to determine the values of a set of constraints associated with an objective function that relates a plurality of performance parameters. The objective function may then be provided to the quantum computing system, which may determine optimal values of the performance parameters by minimizing the objective function using a quantum computational optimization process. Said optimal values may then be output to the classical computing system, which may generate a plan for operating the hybrid energy network in a manner that optimizes the energy network's performance according to one or more metrics (e.g., overall energy output relative to energy demands). This operating plan can then be implemented, manually or automatically, on the energy network.

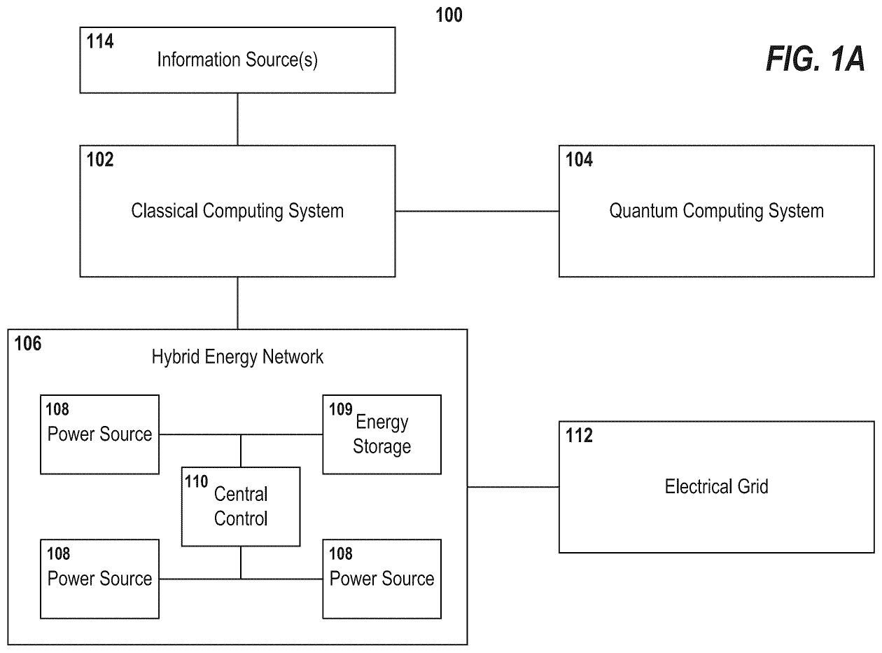

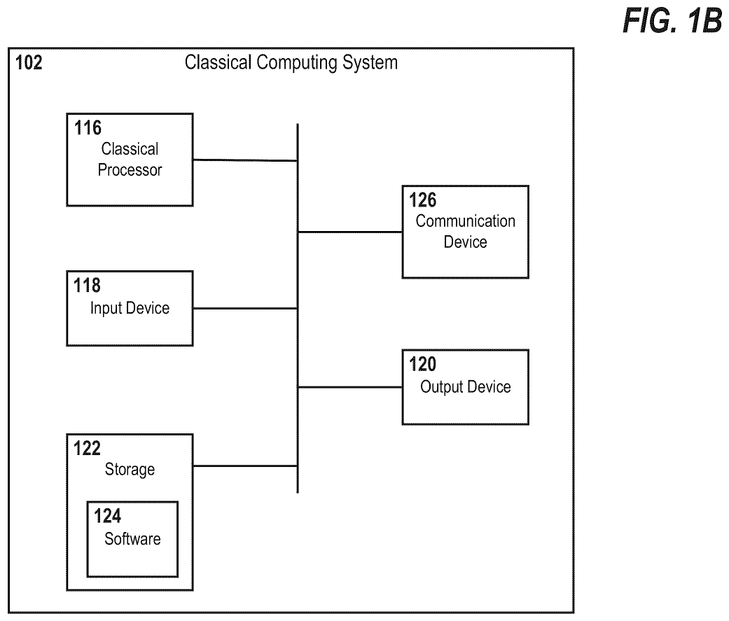

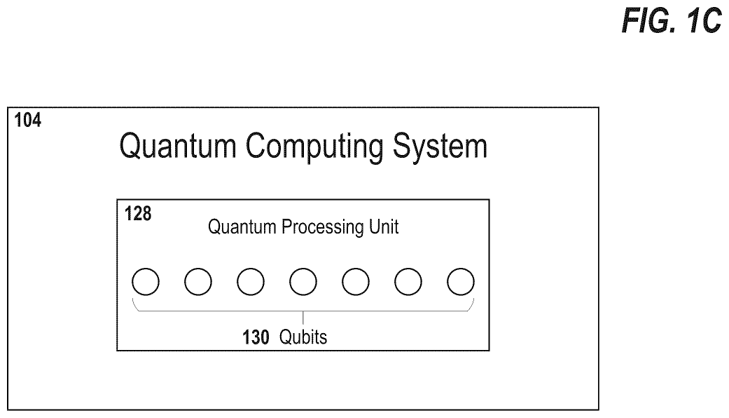

FIG. 1A depicts a block diagram of an exemplary hybrid energy network optimization system 100. As shown, system 100 may include a classical computing system 102 and a quantum computing system 104. System 100 may be configured to improve the performance of a hybrid energy network 106 by using classical computing system 102 and quantum computing system 104 to determine the optimal values of a plurality of performance parameters associated with energy network 106.

Hybrid energy network 106 may comprise a plurality of power sources 108 as well as an energy storage system 109. Power sources 108 in hybrid energy network 106 may be configured to generate energy from renewable sources or non-renewable sources. For example, a power source 108 may be a fossil fuel power station (e.g., a coal power station or a natural gas power station), a nuclear power station, a solar panel or collection of solar panels, a wind turbine or collection of wind turbines, a geothermal power station, or a hydroelectric dam. Hybrid energy network 106 may be configured supply energy generated by power sources 108 to an electrical grid 112 for a location such as a home, a town, a city, or a county. The number of power sources 108 in energy network 106 may depend on the energy demands of electrical grid 112. In various embodiments, hybrid energy network 106 can include at least 2, at least 3, at least 4, at least 5, at least 6, at least 7, at least 8, at least 9, or at least 10 distinct power sources 108.

Power sources 108 in hybrid energy network 106 may be monitored and controlled by a central network control system 110. Central control system 110 may comprise energy transmission infrastructure (e.g., power lines), heat management infrastructure (e.g., cooling systems), energy conversion apparatuses (e.g., turbines, alternators, etc.), processors, control circuitry, or a combination thereof. Control system 110 can also control and monitor energy storage system 109, which may comprise one or more energy storage devices (e.g., batteries) configured to store energy generated by one or more of power sources 108. In some embodiments, classical computing system 102 is a component of, or is configured to interface with, network control system 110.

Classical computing system 102 can be any suitable type of microprocessor-based device, such as a personal computer, workstation, server, or handheld computing device (portable electronic device) such as a phone or tablet, or dedicated device. As shown in FIG. 1B, classical computing system 102 may include one or more classical (i.e., binary) processors 116, an input device 118, an output device 120, storage 122, and a communication device 126.

Input device 118 and output device 120 can be connectable or integrated with the computer. Input device 118 may be any suitable device that provides input, such as a touch screen, keyboard or keypad, mouse, or voice-recognition device. Likewise, output device 120 can be any suitable device that provides output, such as a display, touch screen, haptics device, or speaker.

Storage 122 can be any suitable device that provides (classical) storage, such as an electrical, magnetic, or optical memory, including a RAM, cache, hard drive, removable storage disk, or other non-transitory computer readable medium. Communication device 126 can include any suitable device capable of transmitting and receiving signals over a network, such as a network interface chip or device. The components of classical computing system 102 can be connected in any suitable manner, such as via a physical bus or via a wireless network.

Processor(s) 116 may be or comprise any suitable classical processor or combination of classical processors, including any of, or any combination of, a central processing unit (CPU), a field programmable gate array (FPGA), and an application-specific integrated circuit (ASIC). Software 124, which can be stored in storage 122 and executed by processor(s) 116, can include, for example, the programming that embodies the functionality of the present disclosure. Software 124 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 122, that can contain or store programming for use by or in connection with an instruction execution system, apparatus, or device.

Software 124 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Classical computing system 102 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Classical computing system 102 can implement any operating system suitable for operating on the network. Software 124 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Classical computing system 102 may be communicatively coupled to one or more information sources 114, as shown in FIG. 1A. Information source(s) may be digital or human sources that store and/or provide information about various operating conditions of hybrid energy network 106. The operating conditions can be any environmental or structural conditions that may impact the ability of hybrid energy network 106 to draw power from a given power source 108. The conditions that are relevant to network 106 may depend on the specific types of power sources 108 in network 106. For example, if a power source 108 in network 106 includes a solar panel, relevant operating conditions of network 106 may be the time of day and the weather conditions (e.g., amount of cloud cover) in a vicinity of the solar panel. Information about such operating conditions may be received by classical computing system 102 from (for example) a clock (e.g., a clock implemented within classical computing system 102) and a database of meteorological data.

Classical computing system 102 may also be communicatively coupled to quantum computing system 104. Quantum computing system 104 may be any suitable quantum-processor-based device. In other words, as illustrated in FIG. 1C, quantum computing system 104 may be any device comprising a quantum processing unit (QPU) 128 configured to perform computational operations by encoding information in and manipulating the quantum states of one or more qubits 130. In some embodiments, quantum computing system 104 may be or may comprise a specific class of quantum computer such as, e.g., a quantum annealer.

Each qubit 130 may be a two-state quantum mechanical system. Possible implementations of qubits 130 can include, in non-limiting examples, electrons (e.g., electron spin qubits), photons (e.g., polarization encoding or time bin encoding qubits), atomic nuclei (e.g., nuclear spin encoded qubits), quantum dots, Josephson junctions (e.g., flux qubits), and solid-state defects (e.g., nitrogen vacancy centers in diamond).

To facilitate the encoding and manipulation of information, quantum computing system 104 may include devices such as lasers, microwave radiation sources, voltage sources, current sources, digital-to-analog converters, application specific integrated circuits (ASICs), and field programmable gate arrays (FPGAs). Additionally, quantum computing system 104 may include any environmental control components necessary to stabilize qubits 130. For example, quantum computing system 104 may include apparatuses configured to control the temperature of qubits 130. Quantum computing system 104 can also include one or more classical computing devices (e.g., CPUs or GPUs) configured to interface with QPU 128 to (for example) compile instructions for a given quantum algorithm to be executed by the quantum computing system 104 or process quantum-state measurements after the quantum algorithm is executed. In some embodiments, quantum computing system 104 may share one or more components with classical computing system 102.

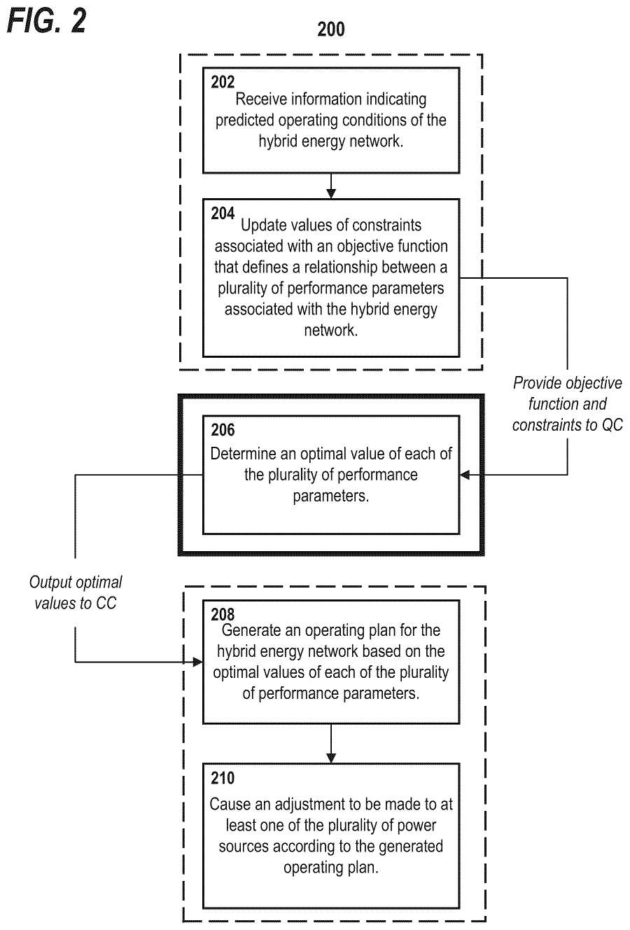

An exemplary method 200 for optimizing the performance of a hybrid energy network is provided in FIG. 2. Method 200 may be executed by a system comprising a classical computing system (e.g., classical computing system 102 shown in FIGS. 1A-1B) and a quantum computing system (e.g., quantum computing system 104 shown in FIGS. 1A and 1C). In some embodiments, method 200 can be performed on a regular, pre-scheduled basis (e.g., once per day). Method 200 may also be initiated by the detection or prediction of certain events (e.g., severe or unusual weather patterns or equipment failure within the hybrid energy network) or by request from a user.

As shown, method 200 may begin with the receipt, by the classical computing system, of information pertaining to one or more operating conditions of the hybrid energy network. Specifically, method 200 may begin with the receipt, by the classical computing system, of information that indicates one or more predicted operating conditions of the hybrid energy network (step 202). In some embodiments, the information indicating the predicted operating conditions can include information indicating a predicted weather condition in a vicinity of the hybrid energy network, information indicating a predicted load on energy stores (e.g., batteries) within the hybrid energy network, information indicating a predicted change in energy demand from the electrical grid supplied by the hybrid energy network, or information indicating a predicted equipment or component issue within the hybrid energy network (e.g., a predicted failure of a particular power source). The classical computing system may receive this information from a user (e.g., via a user interface), from the hybrid energy network (e.g., from sensors or monitoring systems within the hybrid energy network), from the electrical grid supplied by the hybrid energy network (e.g., from sensors or monitoring systems within the electrical grid, or from digital databases (e.g., databases storing meteorological data).

Different subsets of the received information may correspond to different time segments. For example, a first subset of the received information may indicate one or more predicted operating conditions of the hybrid energy network during a first time segment, a second subset of the received information may indicate one or more predicted operating conditions of the hybrid energy network during a second time segment, and so on. Each time segment may correspond to specific period of time, such as a period of hours in a day, a period of days in a week, a period of weeks in a month, or a period of months in a season. This may enable the performance of the hybrid energy network to be adjusted over the course of several upcoming time segments as the operating conditions of the energy network change.

After the information indicating the predicted operating conditions of the hybrid energy network is received by the classical computing system, the classical computing system may update the values of one or more constraints associated with an objective function that relates a plurality of performance parameters associated with the hybrid energy network (step 204). The performance parameters defined by the objective function may be controllable variables associated with hybrid energy network such as, e.g., the amount of energy that the hybrid energy network should draw from each available power source during one or more upcoming time segments. The objective function may be chosen such that the values of the performance parameters that extremize (e.g., maximize or minimize) the objective function are correlated with adjustments that can be made to the hybrid energy network to improve its performance.

The objective function may be stored in the memory of the classical computing system. The classical computing system may be configured to use the operating condition information received in step 202 to constrain the values of various variables in the objective function, including the values of the performance parameters. Constraints associated with the objective function can include (but are not limited to):
a constraint on an amount of power that a power source is capable of outputting during a given time segment based on operating conditions occurring within said time segment (e.g., a maximum amount of power that a solar panel is capable of outputting during a time segment when cloud cover in vicinity of the solar panel is predicted to be heavy);
a constraint on a total amount of power that the hybrid energy network needs to output in a time segment (e.g., a minimum total amount of power that the hybrid energy network must produce during a time segment order to satisfy energy demand for that time segment); and
a constraint on the energy storage capacity of the hybrid energy network (e.g., a maximum energy storage capacity of the hybrid energy network based on current and predicted future energy store levels).

Updating the values of the constraints associated with the objective function may ensure that the objective function accurately represents the relationships between the performance parameters at the time segment(s) of interest.

After the values of the constraints associated with the objective function are updated by the classical computing system, the objective function, along with the constraints, may be provided to the quantum computing system. Using the quantum computing system, the optimal values of the performance parameters may be determined (step 206).

The quantum computing system may be configured to determine the optimal performance parameter values by extremizing (e.g., minimizing or maximizing) the objective function in view of the associated constraints. In some embodiments, the problem of extremizing the objective function is in the NP complexity class and thus may be represented as a constrained quadratic model (CQM) problem or a quadratic unconstrained binary optimization problem (QUBO). The forms of these problems are indicated in Table 1.

TABLE 1
CQM and QUBO problems

| Problem | Objective Function | Constraints |
|---|---|---|
| CQM | ${\sum }_{i} {a}_{i} {x}_{i} + {\sum }_{i \leq j} {b}_{ij} {x}_{i} {x}_{j} + c$ | xᵢ is a binary, integer, or real-valued variable; |
| | | aᵢ, bᵢⱼ, and c are real numbers; |
| | | m = 1, . . . , M, where M is the total |
| | | number of constraints, and |
| | | ${\sum }_{i} {a}_{i}^{( m )} {x}_{i} + {\sum }_{i \leq j} {b}_{ij}^{( m )} {x}_{i} {x}_{j} + {c}^{( m )} ∘ 0$ |
| | | where ○ ∈ {≥, ≤, =}. |
| QUBO | ${\sum }_{i \leq j} {x}_{i} {Q}_{i , j} {x}_{j}$ | Q is an upper-diagonal matrix; and xᵢ is a binary variable. |

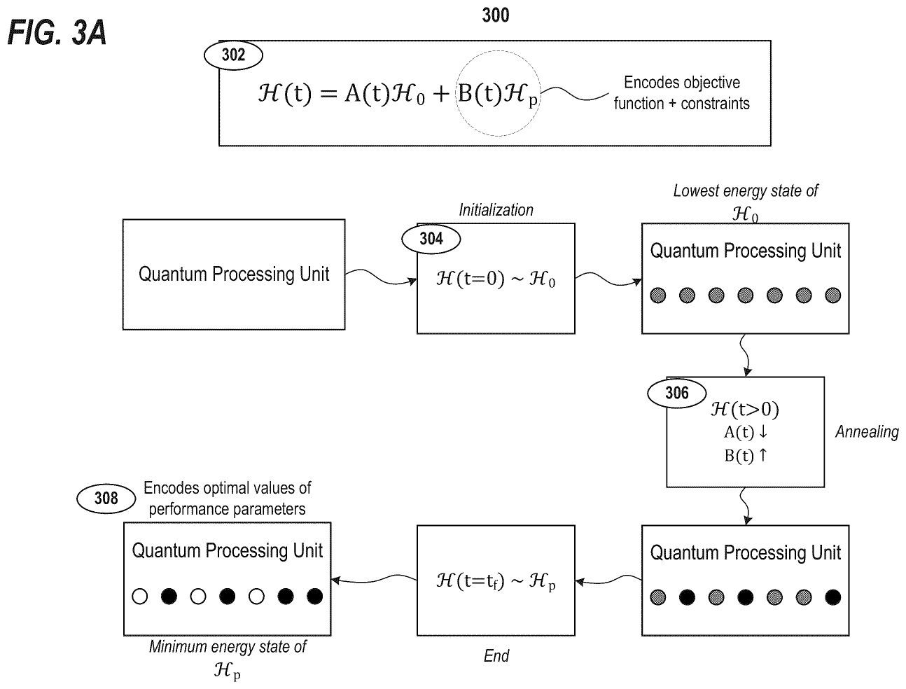

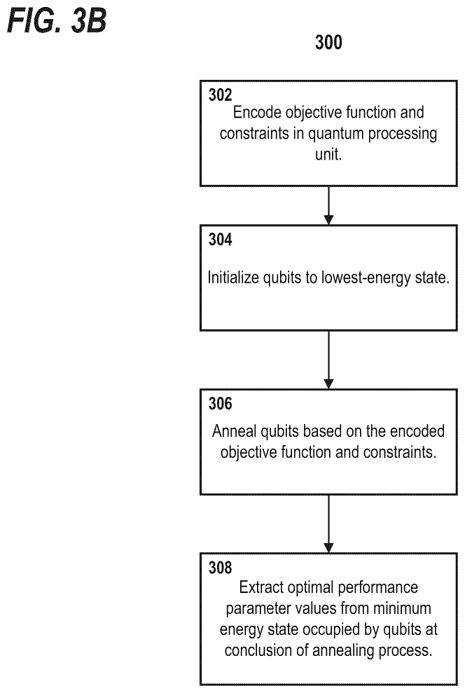

To extremize the objective function, the quantum computing system may execute a quantum optimization process such as quantum annealing. A visual representation of an exemplary quantum annealing process 300 is depicted in FIG. 3A and a corresponding flowchart is provided in FIG. 3B.

To begin the annealing process, the objective function and the associated constraints may be encoded as a time-dependent term ( [symbol] ₚ, sometimes referred to as the “final Hamiltonian” or the “problem Hamiltonian”) in a Hamiltonian operator ( [symbol] (t)) for qubits in the quantum computing system (step 302). The lowest energy state of this “final Hamiltonian” may correspond to the extremized value of the objective function. Encoding the objective function and the associated constraints in the Hamiltonian may require mapping the logical representations of the function and the constraints onto the physical qubit topology of the quantum computer, e.g., using minor-embedding. This mapping process may be performed manually by a user (e.g., via a user interface that enables the user to interact directly with the quantum computing system) or automatically by a classical computing system configured to interface directly with the quantum computer (e.g., as done by D-Wave's LeapHybridSampler solver). At this stage, annealing parameters such as the total annealing time may also be set, either by a user or automatically.

In addition to the “final Hamiltonian” term, the Hamiltonian operator may include an “initial Hamiltonian” (also known as a “tunnelling Hamiltonian” or “driving Hamiltonian”) term ( [symbol] ₀). As previously noted, each qubit in the quantum computer may be a two-state quantum mechanical system; the ground state of the “initial Hamiltonian” may be a superposition of all states of the qubit system.

The functions A(t) and B(t) may be configured to adjust the weights of the initial Hamiltonian and the final Hamiltonian, respectively, as the annealing process progresses. In other words, A(t) and B(t) may be configured such that, as the annealing process progresses (e.g., as the annealing time parameter t increases from a start time of t=0), the influence of the initial Hamiltonian on the qubits grows weaker and the influence of the final Hamiltonian on the qubits grows stronger, thereby causing the states of qubits to evolve toward the lowest energy state of the final Hamiltonian. In other words, at the start of the annealing process (t˜0), A(t)>>B(t) and, as a result, [symbol] (t)˜ [symbol] ₀.

After the objective function and the associated constraints are encoded in the final Hamiltonian, the qubit system may be initialized to the lowest energy state of [symbol] ₀ (step 304). As the annealing process progresses and the time parameter increases (t>0), the magnitude of A(t) relative to the magnitude of B(t) may decrease, reducing the influence of the initial Hamiltonian and increasing the influence of the final Hamiltonian on the qubits (step 306). The quantum computing system may be configured to execute this process slowly and to minimize interference by energy sources external to the quantum computing system (i.e., to execute the process as close to adiabatically as possible). By the end of the annealing process (t˜t_{f}, where t_{f} is the total annealing time), A(t)<<B(t) and [symbol] (t)˜ [symbol] ₚ. As a result, at the end of the annealing process, the qubits may occupy the lowest energy state of [symbol] ₚ. From this state, information indicating the values of the performance parameters that extremize the objective function may be extracted (step 308).

Once the performance parameter values that extremize the objective function are determined by the quantum computing system, information indicating the optimal performance parameter values may be output to the classical computing system, as indicated in method 200 shown in FIG. 2. The classical computing system may use the performance parameter values to generate an operating plan for the hybrid energy network (step 208). One or more of the power sources in the hybrid energy network may then be adjusted according to the generated operating plan (step 210). Adjustments that can be made to a power source in the hybrid energy network may include (but are not limited to) adjustments to an amount of power that the power source provides to the hybrid energy network over a given time period, adjustments to a time period in which the power source is generating power, adjustments to an amount of energy received from the power source that is reserved for storage, or a combination thereof. In some embodiments, to cause adjustments to be made to a power source according to the operating plan, the classical computing system outputs the operating plan to a user, for example by displaying a graphical representation of operating plan on a user interface or by transmitting information indicating the operating plan to a user device. The user may then make manual adjustments to the power source according to the operating plan. In other embodiments, the classical computing system may be configured to automatically adjust a power source according to the operating plan, for example by interfacing with a centralized control system in the hybrid energy network (e.g., central control 110 shown in FIG. 1A).

### Example Objective Function

The information contained in the objective function may vary based on the operating condition information that is available, the performance parameters being considered, and various characteristics of the hybrid energy network (e.g., the number of power sources in the network). In some examples, the objective function may contain a first term α(t) configured to capture a monetary cost associated with operating the hybrid energy network during a given time segment and a second term β(t) configured to capture a fluctuation rate of the power output by the hybrid energy network during a given time segment, as indicated by Equation 1:

$${f}_{obj} = α ( t ) + β ( t ) \qquad ( 1 )$$

The monetary cost term a(t) may be given by Equation 2:

$$α ( t ) = {c}_{1} {P}_{B} + {c}_{2} {E}_{B} + {\sum }_{t = 1}^{N} [ e ( t ) {p}_{Grid} ( t ) ] \qquad ( 2 )$$

where:
c₁ may represent a cost incurred when an energy storage system (e.g., a battery system) in the hybrid energy network to discharge a unit of power;
P_{B} may represent a total amount of power output by the energy storage system;
c₂ may represent a cost to store a unit of energy in the energy storage system;
E_{B} may represent a total amount of energy stored in the energy storage system;
e(t) may represent the price of power from a secondary energy system at a given time segment t;
P_{Grid}(t) may represent the total amount of available power in the hybrid energy network at a time segment t; and
N may represent a total number of time segments over which the performance of the hybrid energy network is to be optimized.

The total amount of power output by the energy storage system, P_{B}, may be determined based on the power output by the energy storage system at each time segment—e.g., P_{B}=Σₜ₌₁^{N}p_{B} (t), where p_{B}(t) represents the power output by the battery system at a time segment t. p_{B}(t) >0 may indicate that the energy storage system contains surplus power generated by the power sources in the hybrid energy network. p_{B}(t)<0 may indicate that the energy storage system is discharging power to support the power demands on the hybrid energy network.

The total power stored by the energy storage system, E_{B}, may be determined based on the amount of power that is stored by the battery system after each time segment. In some embodiments, for instance, E_{B}(t)=E_{B} (t−1)+p_{B}(t)Δt. That is, the amount power stored by the energy storage system at a given time segment t, E_{B}(t), may be based on the amount of power stored by the energy storage system at the previous time segment t−1, E_{B}(t−1), and the power that is output by the energy storage system at the given time segment t, p_{B} (t). Initially, there may not be any power stored in the energy storage system, so E_{B}(0)=0. Additionally, the power output by the energy storage system p_{B}(t) may continue for the duration of a given time segment, and thus At may represent the actual amount of time corresponding to a time segment. For example, if the objective function, and in turn the monetary cost term, is applied to N=6 time segments in a day, then

$$Δ t = \frac{24 hr / day}{6 time segments / day} = 4 hours per time segment .$$

The price of power on a separate energy system, e(t), may be included in the monetary cost term of the objective function in order to account for any periods of time when the hybrid energy network is not able to provide enough power to meet energy demands. This may be the case when the amount of power that needs to be discharged from the hybrid energy network to meet the demand is greater than the amount of power that is available from the hybrid energy network via the various power sources in the hybrid energy system. As a result, power may need to be purchased from a separate energy network to supplement the power produced by the hybrid energy network in order to meet energy demands. In various embodiments, the separate energy network from which supplemental power is purchased may be any energy system that is not directly connected to the hybrid energy network, such as a national power grid.

The overall amount of power on the hybrid energy network at a time segment t, P_{Grid}(t), may be determined based on the load on the hybrid energy network and the amount of power being provided by the power sources of the hybrid energy network at that time segment. For example, if a hybrid energy network includes photovoltaic cells (solar panels) and wind turbines, P_{Grid}(t)=p_{Load}(t)−p_{PV}(t)−p_{WT}(t)+p_{B}(t), where P_{Load}(t) may represent the load on the hybrid energy system at time segment t, p_{PV}(t) may represent the power generated by the photovoltaic cells of the hybrid energy network at time segment t, p_{WT}(t) may represent the power generated by the wind turbines of the hybrid energy network at time segment t, and p_{B} (t) may represent the power stored by the energy storage system of the hybrid energy network at time segment t. In some embodiments, the amounts of power provided by each power source in the hybrid energy network at a given time segment may correspond to or may be the performance parameters that are determined by extremizing the objective function.

The number of time segments, N, may represent the number of time segments in a given time period for which the values of performance parameters may be determined by optimizing the objective function. If, for example, the given time period is one day, and the number of time segments Nis set to six, the day-long period may be divided into six time segments. Optimal values of the performance parameters may be determined for each of the six time segments to optimize the performance of the hybrid energy network during each of the time segments. Since one day has 24 hours, each of the six segments may correspond to four hours. Thus, the operating plan for the hybrid energy network that is generated (e.g., by executing method 200 shown in FIG. 2) may indicate how the performance of the hybrid energy network can be optimized in each of the four hour segments of the day.

The power fluctuation term β(t) in the objective function (Equation 1) may be given by Equation 3:

$$β ( t ) = λ \frac{1}{N} {\sum }_{t = 1}^{N} {[ {p}_{Grid} ( t ) - \overline{P} ]}^{2} \qquad ( 3 )$$

The fluctuation term may include similar components as the monetary cost term as well as additional components, such as:
λ, which may represent a penalty factor that weights the fluctuation term in the objective function; and
P̅, which may represent the average power on the hybrid energy network. [ ]

The penalty factor, λ, may be selected by a user and may determine the amount of influence that the fluctuation term has on the objective function. Larger λ values may increase the influence of the fluctuation term on the objective function, while smaller λ values may decrease the influence of the fluctuation term on the objective function.

The average power on the hybrid energy network, P̅, may be determined based on the average power on the energy network across the various time segments. Specifically,

$$\overline{P} = \frac{1}{N} {\sum }_{t = 1}^{N} {P}_{Grid} ( t ) .$$

### Thus

$$\frac{1}{N} {\sum }_{t = 1}^{N} {[ {p}_{Grid} ( t ) - \overline{P} ]}^{2}$$

may represent the variance in the power on the hybrid energy network, which may indicate fluctuations in the power on the hybrid energy network.

### Example Operating Condition Information and Constraints

The operating condition information for the hybrid energy network depend on various characteristics of the hybrid energy network, including the network's location, the size of the network, and the types of power sources included in the network. The operating condition information may be formatted to correspond to the different time segments that for which optimal values of performance parameters are to be determined. For example, if performance parameter values are to be determined for a total of six time segments, operating condition information indicating a predicted load on the energy stores in a hybrid energy network may contain six data points, as shown in the following example:

p_{load}=[1.2e7,1.18e7, 1.13e7,1.08e7,1.05e7,1.06e7]

Each data point in the data set may correspond to a predicted load on a battery in the hybrid energy network at one of the six time segments.

The operating condition information may explicitly indicate an operating condition or may be derived based on an operating condition. For example, the weather in a vicinity of a hybrid energy network may be a relevant operating condition if the network contains photovoltaic cells. Accordingly, the operating condition data may contain explicit weather data (e.g., data indicating amounts of sunlight expected during a given time period). Alternatively (or in addition) to the explicit weather data, the operating condition information may include information indicating a maximum amount of power that the photovoltaic cell is capable of generating at each time segment. If performance parameter values are to be determined for a total of (for instance) six time segments, then the operating condition information indicating the maximum amount of power that can be produced by the photovoltaic cell may contain six data points, as shown in the following example:

PVᵤₚₚ=[0,77,460,600,260,0]

This example indicates that, at the first time segment, the expected maximum power generated by the photovoltaic cell is 0 kW. The maximum amount of power may increase to 77 kW at the second time segment, and then to 460 kW at the third time segment, and so on. The variation in the maximum amount of power that the photovoltaic cell can generate during a given time segment may be correlated with predicted weather conditions at said time segment.

The operating condition data may be used to constrain the performance parameters of interest. For example, based on the example operating condition information PVᵤₚₚ, a performance parameter indicating an amount of power that should be drawn from the photovoltaic cell by the hybrid energy network during a given time, p_{PV}(t), segment may be constrained. During the second time segment, for instance, the amount of power that should be drawn from the photovoltaic cell by the hybrid energy network during a given time may be constrained between 0 W and 77 W.

Other constraints may include, e.g., constraints on an amount of power that an energy storage system in the hybrid energy network is capable of storing or outputting. Such constraints may depend on characteristics of the energy storage devices used in the network's energy storage system. The operating condition information may indicate such constraints directly or by indicating the types or number of energy storage devices included in the energy storage system.

In some embodiments, the times of day in which a power source in the hybrid energy network is able to supply power may be constrained. For example, if the hybrid energy network includes a photovoltaic cell, said photovoltaic cell may be incapable of generating power after the sun sets. Accordingly, the amount of power that can be drawn from the photovoltaic cell (p_{PV}) at night (e.g., between the time at which the sun sets, tₛᵤₙₛₑₜ, and the time at which the sun rises, tₛᵤₙᵣᵢₛₑ) may be set to zero (p_{PV}(tₛᵤₙₛₑₜ≤t≤tₛᵤₙᵣᵢₛₑ)=0). In this example, the times at which the sun sets and rises may be provided in the operating condition data.

In some embodiments, the operating condition information may constrain the state of charge (SOC) of an energy storage system in the hybrid energy network. The SOC may indicate the amount of power that is available in the energy storage system. In order to preserve the health of the energy storage devices in the energy storage system, the SOC for the energy storage system may need to be maintained within a certain range. The SOC at a given time segment t may be based on the SOC during the previous time segment t−1, the power that is output by the energy storage system at that time segment, and the total power that is stored by the energy storage system. In some embodiments,

$$SOC ( t ) = SOC ( t - 1 ) + \frac{γ ( t ) {p}_{B} ( t ) Δ t}{{E}_{B}}$$

Here, γ(t) may represent the charging and discharging efficiency of the energy storage system. For example,

$$γ ( t ) = \{ \begin{matrix}{η}_{c} {p}_{B} ( t ) > 0 ( energy storage system is charging ) , \\ \frac{1}{{η}_{d}} {p}_{B} ( t ) \leq 0 ( energy storage system is discharging )\end{matrix}$$

where η_{c} may represent the charging efficiency of the energy storage system and η_{d} may represent the discharging efficiency of the energy storage system. If, at a time t₁, the energy storage system has no energy stored, SOC(t₁)=0%. Similarly, if, at a time t₂, the energy storage system is fully charged, then SOC(t₂)=100%

In some embodiments, the overall output power of the hybrid energy network, P_{Grid}(t), is also constrained such that the output power at any time segment is less than the maximum power P_{L0} and larger than the minimum power −P_{G0}. The maximum power and the minimum power may be input by a user familiar with the electricity grid that the hybrid energy network is supplying.

### Example Operating Plan

An operating plan generating according to the provided methods may indicate an amount of power that should be drawn by the hybrid energy network from each of the power sources in the network at each time segment of interest. For example, for a hybrid energy network that includes photovoltaic cells and wind turbines, the operating plan for a set of six time segments may include the following datasets:

p_{PV}(t)=[0.0,28.39,275.23,304.99,14.83,0.0]

p_{WT}(t)=[1040.45,993.88,879.02,737.52,891.81,858.89]

Through these datasets, the operating plan may indicate that, to optimize the performance of the hybrid energy network at the first time segment, the output of the photovoltaic cells should be 0 kW and the output of the wind turbines should be 1040.45 kW during the first time segment; to optimize the performance of the hybrid energy network at the second time segment, the output of the photovoltaic cells should be 28.39 kW and the output of the wind turbines should be 993.88 kW during the second time segment; and so on.

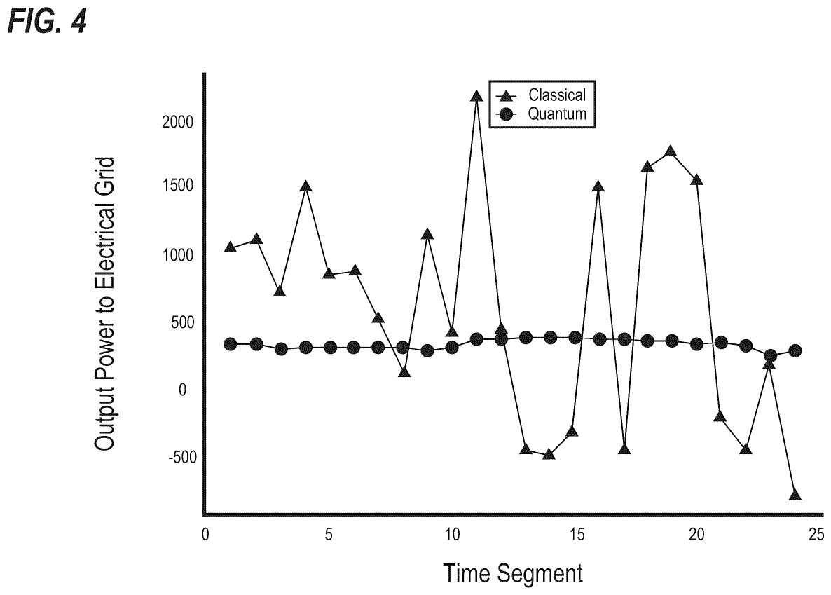

FIG. 4 shows example data comparing the energy output of a hybrid energy network when it is operated according to the methods described herein to the energy output of the hybrid energy network when it is operated using solely classical techniques (e.g., by using a genetic algorithm to determine the optimal values of performance parameters). Time segments are provided along the x-axis. In this example, twenty-four segments representing each of the twenty-four hours in a day are provided. The y-axis indicates the output power of the hybrid energy network at each time segment. As shown, the quantum-computing-based approach provided herein may enable the hybrid energy network to maintain a consistent overall output power across the various time segments, while the classical-computing-based approach resulted in substantial output power fluctuations across the various time segments.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method for operating a hybrid energy network comprising a plurality of power sources, the method comprising:
receiving information indicating predicted operating conditions of the hybrid energy network;
updating, based on the received information, values of one or more constraints associated with an objective function that defines a relationship between a plurality of performance parameters associated with the hybrid energy network;
determining, using a quantum computing system, based on the objective function and the updated values of the one or more constraints, an optimal value of each of the plurality of performance parameters;
generating an operating plan for the hybrid energy network based on the optimal values of each of the plurality of performance parameters; and
causing an adjustment to be made to at least one of the plurality of power sources according to the generated operating plan.

2. The method of claim 1, wherein the quantum computing system is a quantum annealer.

3. The method of claim 2, wherein determining the optimal values of the plurality of performance parameters comprises solving a quadratic unconstrained binary optimization (QUBO) problem.

4. The method of claim 2, wherein determining the optimal values of the plurality of performance parameters comprises solving a constrained quadratic model (CQM) problem.

5. The method of claim 1, wherein the information indicating predicted operating conditions of the hybrid energy network comprises information about a predicted weather condition.

6. The method of claim 1, wherein the information indicating predicted operating conditions of the hybrid energy network comprises information about a predicted load on an energy store of the hybrid energy network.

7. The method of claim 1, wherein a first constraint of the one or more constraints associated with the objective function indicates a maximum amount of power that a power source of the plurality of power sources is capable of outputting during a given time period.

8. The method of claim 1, wherein a second constraint of the one or more constraints associated with the objective function indicates a minimum total amount of power that the hybrid energy network should produce during a given time period.

9. The method of claim 1, wherein a third constraint of the one or more constraints associated with the objective function indicates a maximum total amount of power that the hybrid energy network should produce during a given time period.

10. The method of claim 1, wherein a fourth constraint of the one or more constraints associated with the objective function indicates a maximum energy storage capacity of the hybrid energy network.

11. The method of claim 1, wherein the objective function comprises a first term configured to capture a monetary cost associated with operating the hybrid energy network during a given time period.

12. The method of claim 1, wherein the objective function comprises a second term configured to capture a fluctuation rate of a total amount of power output by the hybrid energy network during a given time period.

13. The method of claim 1, wherein each of the plurality of performance parameters corresponds to an amount of power sourced from a power source of the plurality of power sources.

14. The method of claim 1, wherein an adjustment to be made to at least one of the plurality of power sources according to the generated operating plan comprises automatically updating an amount of power sourced from each of the plurality of power sources.

15. A system for operating a hybrid energy network comprising a plurality of power sources, the system comprising:
a classical computing system; and
a quantum computing system,
wherein the system is configured to:
receive, using the classical computing system, information indicating predicted operating conditions of the hybrid energy network;
update, using the classical computing system, based on the received information, values of one or more constraints associated with an objective function that defines a relationship between a plurality of performance parameters associated with the hybrid energy network;
determine, using the quantum computing system, based on the objective function and the updated values of the one or more constraints, an optimal value of each of the plurality of performance parameters;
generate, using the classical computing system, an operating plan for the hybrid energy network based on the optimal values of each of the plurality of performance parameters; and
cause, using the classical computing system, an adjustment to be made to at least one of the plurality of power sources according to the generated operating plan.

16. The system of claim 15, wherein the quantum computing system is a quantum annealer.

17. The system of claim 16, wherein the quantum computing system determines the optimal values of the plurality of performance parameters by solving a quadratic unconstrained binary optimization (QUBO) problem.

18. The system of claim 16, wherein the quantum computing system determines the optimal values of the plurality of performance parameters by solving a constrained quadratic model (CQM) problem.

19. The system of claim 15, wherein each of the plurality of performance parameters corresponds to an amount of power sourced from a power source of the plurality of power sources.

20. The system of claim 15, wherein the classical computing system is configured to cause adjustment to be made to at least one of the plurality of power sources according to the generated operating plan by automatically updating an amount of power sourced from each of the plurality of power sources.
